(19) United States
(12) Patent Application Publication
(10) Pub. No.: US 2017/0223614 A1
(43) Pub. Date: Aug. 3, 2017

(54) COMMUNICATION APPARATUS, COMMUNICATION CONTROL METHOD, AND NON-TRANSITORY COMPUTER-READABLE RECORDING MEDIUM

(71) Applicant: KYOCERA Corporation, Kyoto (JP)

(72) Inventors: Shuji ISHIKAWA, Yokohama-shi (JP); Yasuhiro ITO, Tokyo (JP); Tomoya KAMIJO, Yokohama-shi (JP); Hidetaka HAYASHI, Yokohama-shi (JP); Kohei MICHIGAMI, Yokohama-shi (JP); Kazuo ONISHI, Yokohama-shi (JP); Kazuya CHITO, Tokyo (JP)

(73) Assignee: KYOCERA Corporation, Kyoto (JP)

(21) Appl. No.: 15/413,966

(22) Filed: Jan. 24, 2017

(30) Foreign Application Priority Data
Feb. 3, 2016 (JP) 2016-019034

(51) Int. Cl. H04W 48/14; H04L 12/46

(52) U.S. Cl. CPC H04W 48/14; H04L 12/4679; H04W 84/12

(57) ABSTRACT

A communication apparatus includes a controller that prohibits data communication by default, receives a request for data communication from an application, and permits data communication of the application in accordance with a protocol of the data communication requested by the application issuing the request.

### CROSS-REFERENCE TO RELATED APPLICATIONS

This application claims priority to and the benefit of Japanese Patent Application No. 2016-19034 filed on Feb. 3, 2016, the entire contents of which are incorporated herein by reference.

### TECHNICAL FIELD

This disclosure relates to a communication apparatus, a communication control method, and a non-transitory computer-readable medium.

### BACKGROUND

Communication apparatuses such as mobile terminals that can perform data communication have been proposed. Some communication apparatuses may be configured so that data communication by applications running on the communication apparatus is permitted by default. Conversely, some communication apparatuses may be configured so that data communication by applications selected by a user is prohibited.

Data transmitted from the application is associated with an identifier allocated to the application, i.e., an identifier associated with a source of the data. The communication apparatus controls to prohibit the data communication based on the identifier associated with the source of the data. It is demanded that the communication apparatus controls the data communication of the data having no identifier associated with the source of the data.

### SUMMARY

A communication apparatus according to one of the embodiments of this disclosure includes:

a controller configured to

prohibit data communication by default;

receive data communication from an application; and

permit data communication of the application in accordance with a protocol of the data communication requested by the application issuing the request.

A communication control method according to one of the embodiments of this disclosure includes:

on a communication apparatus,

prohibiting data communication by default;

receiving a request for data communication from an application; and

permitting data communication of the application in accordance with a protocol of the data communication requested by the application issuing the request.

A non-transitory computer-readable recording medium according to one of the embodiments of this disclosure includes computer program instructions, which when executed by a computer functioning as a communication apparatus, cause the computer to:

prohibit data communication by default;

receive a request for data communication from an application; and

permit data communication of the application in accordance with a protocol of the data communication requested by the application issuing the request.

### BRIEF DESCRIPTION OF THE DRAWINGS

In the accompanying drawings:

FIG. 1 is a functional block diagram schematically illustrating an example of the structure of a communication apparatus according to Embodiment 1;

FIG. 2 is an external view of an example of the communication apparatus according to Embodiment 1;

FIG. 3 illustrates an example sequence of a communication protocol;

FIG. 4 is a block diagram illustrating an example of the flow of data according to Embodiment 1;

FIG. 5 illustrates the sequence of filtering according to Embodiment 1;

FIG. 6 illustrates an example of a sequence for transmitting data from an application; and

FIG. 7 illustrates the sequence of filtering according to Embodiment 2.

### DETAILED DESCRIPTION

### Embodiment 1

The following describes a communication apparatus according to one of the embodiments in detail with reference to the drawings. The communication apparatus according to this embodiment may be a mobile device, such as a mobile phone or a smartphone. The communication apparatus according to this embodiment, however, is not limited to being a mobile device and may be any of a variety of electronic devices that perform data communication, such as a desktop PC (Personal Computer), a notebook PC, a tablet PC, a household appliance, an industrial device (FA (Factory Automation) device), a dedicated terminal, or the like.

[Configuration of Apparatus]

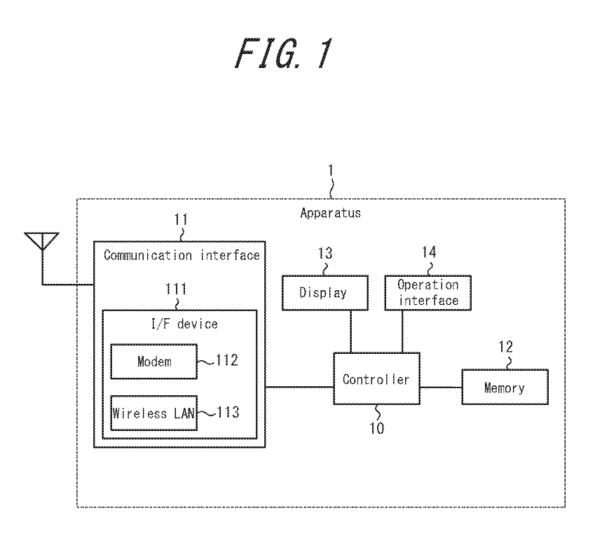

FIG. 1 is a functional block diagram schematically illustrating an example of the structure of a communication apparatus 1 according to this embodiment. As illustrated in FIG. 1, the communication apparatus 1 includes a controller 10, a communication interface 11, a memory 12, a display 13, and an operation interface 14. The controller 10 is connected to and controls the communication interface 11, memory 12, display 13, and operation interface 14.

The controller 10 may be configured by a processor, microcomputer, or the like that can execute an operating system (OS) and application software (application). The OS may, for example, be Android® (Android is a registered trademark in Japan, other countries, or both). The application is described below.

The communication interface 11 is a communication interface that performs cellular communication, wireless LAN (Local Area Network) communication, or the like and is provided with an interface (I/F) device 111. The I/F device 111 includes a modem 112 and a wireless LAN device 113. The communication interface 11 is connected to a network such as the Internet using the I/F device 111 and performs data communication with the network. As a result, the communication apparatus 1 can perform data communication with the network. The communication interface 11 is connected to the controller 10 and acquires data to be output to the network from the controller 10. The controller 10 selects data to output to the communication interface 11 based on filtering. The filtering is described below. The controller 10 also acquires data received from the network from the communication interface 11.

When connecting to the network with a cellular communication method, a pay-as-you-go fee structure is typically adopted, with the communication fee increasing as the amount of transmitted data (packets) increases. On the other hand, when connecting to the network with a method such as wireless LAN communication, such a fee structure is not typical.

The memory 12 may, for example, be configured by a semiconductor memory. A variety of information or data, along with programs for applications, the OS, and the like executed by the controller 10, are stored in the memory 12. The controller 10 acquires and executes programs stored in the memory 12. The controller 10 stores data generated by executing the programs in the memory 12. The memory 12 may also function as a working memory.

The display 13 displays characters, images, objects for operation, pointers, and the like based on information acquired from the controller 10. The display 13 may, for example, be a display device such as a liquid crystal display, an organic EL (Electroluminescence) display, an inorganic EL display, or the like, but is not limited to these examples.

The operation interface 14 may be configured by physical keys such as numeric keys, a touchpad, a touch panel, or the like. In accordance with the content of input acquired from the operation interface 14, the controller 10 performs actions such as moving the pointer or the like displayed on the display 13 and selecting an object for operation.

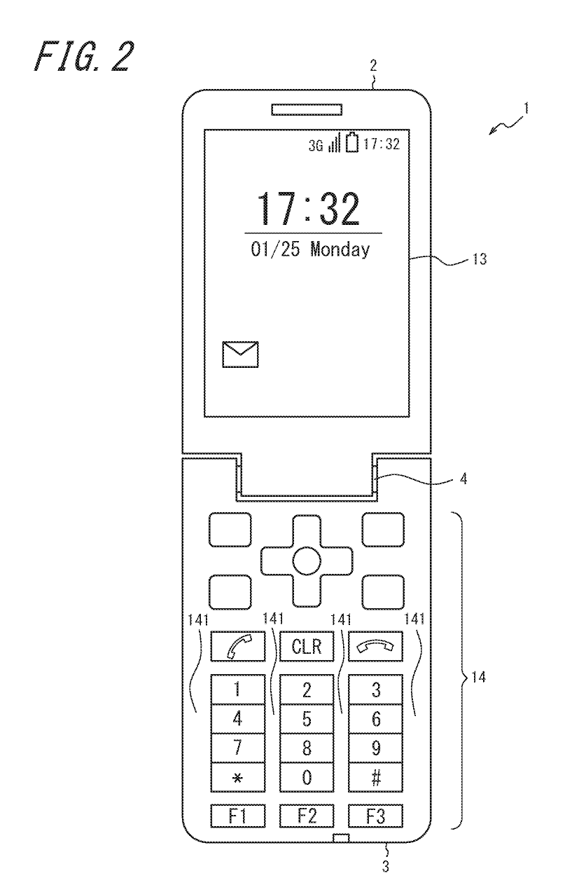

FIG. 2 is an external view of an example of the communication apparatus 1 according to this embodiment. As illustrated in FIG. 2, the communication apparatus 1 according to this embodiment is a folding feature phone (flip phone, clamshell phone, or the like). In the communication apparatus 1, an upper housing 2 and a lower housing 3 are connected by a hinge 4 so as to be rotatable. The upper housing 2 is provided with the display 13, and the lower housing 3 is provided with the operation interface 14. The operation interface 14 is provided with physical keys, such as numeric keys, and with a touchpad 141 at a location where no physical key is provided. The communication apparatus 1 for example receives a selection operation on an object for operation using a physical key or receives a movement operation of a pointer or the like using the touchpad 141.

[Application]

Applications are installed on the communication apparatus 1 and stored in the memory 12 so as to be executable by the controller 10. When the applications are installed on the communication apparatus 1, a unique user identifier (hereinafter, also abbreviated as UID) is allocated to each application. Each application is executed by the controller 10 as a process associated with a UID on the OS.

When executed by the controller 10, an application accesses resources such as the file system. If each application were to access resources without restriction, the resource areas used by the applications would overlap, which might prevent the applications from executing properly. Therefore, access to resources is restricted by the UIDs associated with processes running on the OS, so that applications do not affect each other with their use of resources. In other words, the resources that can be accessed by each process are restricted to resources of the process associated with the same UID.

Each application may be further allocated a group identifier (hereinafter, also abbreviated as GID or group ID). The GID identifies the group to which the unique UID allocated to each application belongs. One UID alone may belong to one group, or a plurality of UIDs may belong to one group. When an application is executed as a process associated with a UID, the process may be also associated with a GID. The restricted resources that can be accessed by each process may be broadened to include not only resources of the process associated with the same UID, but also resources of processes associated with the same GID.

Applications are executed in the foreground or the background. A state in which an application is executed in the foreground is, for example, a state in which the execution status is displayed on the display 13 to allow user confirmation, or a state in which the user can perform operations with the operation interface 14. A state in which an application is executed in the background is, for example, a state in which the execution status is not displayed on the display 13 and the user cannot perform operations, or a state in which the application is running without intent by the user.

[Data Communication Protocol]

The data communication between the OS of the communication apparatus 1 and the network side such as the Internet is performed based on a predetermined communication protocol. According to this embodiment, for example, TCP (Transmission Control Protocol) is used as the communication protocol. However, the communication protocol is not limited to the TCP, and another communication protocol may be used.

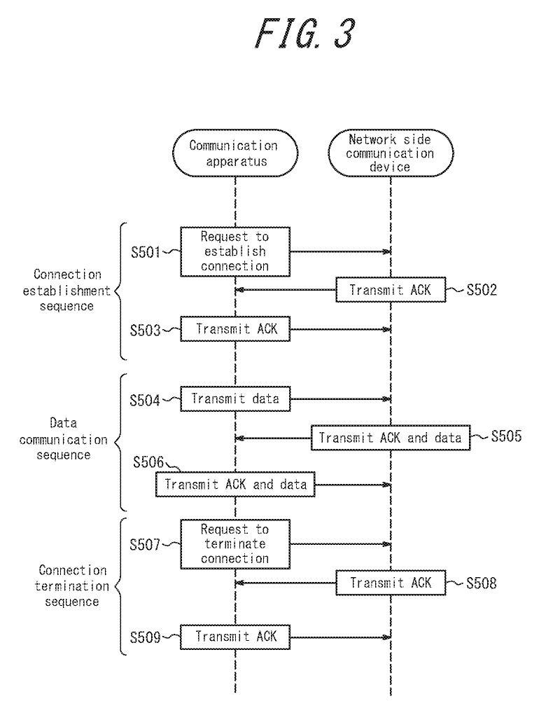

FIG. 3 illustrates an example sequence of TCP. In FIG. 3, the data communication using the TCP is performed between the communication apparatus 1 and a communication device on the network side. The sequence of TCP is broadly classified into connection establishment, data communication, and connection termination.

<Sequence of Connection Establishment>

The communication apparatus 1 transmits, to the communication device on the network side, data containing a request for connection establishment of a communication using the TCP (hereinafter, also referred to as a connection establishment request) (step S501). Subsequently, the communication device on the network side, in response to acquisition of the connection establishment request from the communication apparatus 1, transmits data containing an acknowledgment message (hereinafter, also abbreviated as ACK) (step S502). In the TCP, the ACK is contained in a header of the data.

Then, the communication apparatus 1, in response to acquisition of the ACK from the communication device on the network side, transmits data containing the ACK (step S503). By following the above steps S501 to S503, a connection between the communication apparatus 1 and the communication device on the network side is established.

<Sequence of Data Communication>

The communication apparatus 1, by using the connection established, transmits data to the communication device on the network side (step S504). In response to acquisition of the data from the communication apparatus 1, the communication device on the network side transmits data containing the ACK (step S505). At this time, the data transmitted from the communication device on the network side may contain the ACK alone.

The communication apparatus 1, in response to acquisition of the data from the communication device on the network side, transmits data containing the ACK (step S506). At this time, the data transmitted from the communication apparatus 1 may contain the ACK alone.

By repeating the transmission of the data and the ACK as described at the above steps S504 to S506, the data communication is performed between the communication apparatus 1 and the communication device on the network side.

<Sequence of Connection Termination>

The communication apparatus 1, to the communication device on the network side, transmits data containing a request to terminate the connection of the communication using the TCP (hereinafter, also referred to as a request to terminate connection) (step S507). The communication device on the network side, in response to acquisition of the request to terminate connection from the communication apparatus 1, transmits data containing the ACK. (step S508). The communication apparatus 1, in response to acquisition of the ACK from the communication device on the network side, transmits data containing the ACK (step S509). By following the above steps S507 to S509, the connection between the communication apparatus 1 and the communication device on the network side is terminated.

As described with reference to FIG. 3, in the data communication using the TCP, transmission of the data and transmission of the ACK are performed in pairs. The device transmitting the data may confirm that the data transmission is succeeded by receiving, from a destination device, the ACK corresponding to the data transmitted by the device itself. When the device does not receive the ACK within a predetermined time period after transmitting the data (i.e., when a predetermined time period before timeout is elapsed), the device may retransmit the data or further wait until receiving the ACK.

Here, the ACK will be described further. The ACK is one of particular messages necessary for substantializing a function of the TCP. The ACK contains an ACK flag and an ACK number. The ACK flag is a flag indicative of whether the data contains the ACK. In the TCP, when the ACK flag is 1, it means that the data contains the ACK. On the other hand, when the ACK flag is 0, it means that the data does not contain the ACK.

The ACK number is a number indicative of which data the ACK is associated with. The data transmitted in the TCP are allocated respective sequence numbers for allowing distinctions between the data. Also, the ACK number is a number obtained by adding 1 to the sequence number contained in the data received. For example, an ACK number of an ACK corresponding to data allocated 1000 as a sequence number is 1001. Note that a relationship between the ACK number and the sequence number is not limited to this manner.

Since an initial data of the data communication has no data to return the ACK, the initial data does not contain the ACK. Therefore, in the initial data of the data communication the ACK flag is 0. On the other hand, since data subsequent to the initial data contains the ACK in response to the initial data, ACK flag is 1.

[Control of Data Communication]

The applications executed by the controller 10 perform data communication with a network, such as the Internet, using the communication interface 11. As described above, the applications are each executed as a process associated with a UID on the OS. The UID is also associated with the data transmitted by the application. By determining whether to permit or prohibit (restrict) transmission of data based on the UID associated with the data, the controller 10 can control whether to permit or prohibit data communication for the data transmitted by each application. As a general rule, in the following explanation of this embodiment, data communication refers to data communication between the communication interface 11 and the network.

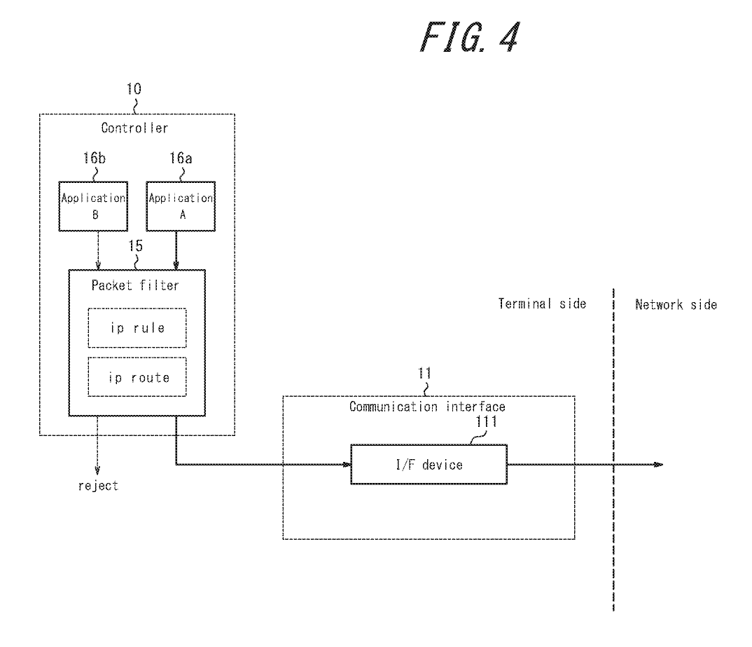

FIG. 4 is a block diagram illustrating an example of the flow of data according to this embodiment. In FIG. 4, the controller 10 and the communication interface 11 are provided on the terminal side. The communication interface 11 is connected to the network and performs data communication with the network.

In FIG. 4, the controller 10 executes an application A 16a and an application B 16b as processes on the OS. The applications executed by the controller 10 request data communication with the network as necessary. Requesting data communication is also referred to as issuing a request of data communication. For example, the application A 16a requests data transmission to the network. In this case, the data to transmit from the application A 16a to the network are input into a packet filter 15 operating in the controller 10. Similarly, data to transmit from the application B 16b to the network are input into the packet filter 15 from the application B 16b.

The packet filter 15 filters data from the controller 10 to the network. The filtering is processing to determine whether to permit or prohibit transmission of data requested by an application based on set filtering conditions. The filtering conditions for example include an ip_rule or an ip_route. These filtering conditions are stored in the memory 12 and referred to by the packet filter 15. Hereinafter, operations to set the filtering conditions are assumed to include operations to store the filtering conditions in the memory 12. The filtering conditions may be held in the controller 10 without being stored in the memory 12.

The ip_rule for example includes a condition for determining whether to transmit data whose source is X to the network. The ip_route for example includes a condition for determining the route (relay router or the like) for transmitting data for which the destination is designated as Y to the network.

In FIG. 4, the flow of data transmitted from the application A 16a is indicated by a solid arrow, whereas the flow of data transmitted from the application B 16b is indicated by a dashed arrow. Of these two, the data transmitted from the application A 16a are transmitted to the communication interface 11 without transmission being prohibited by the filtering in the packet filter 15. On the other hand, the data transmitted from the application B 16b are prohibited by the filtering in the packet filter 15 and are not transmitted to the communication interface 11. This operation is indicated by the dashed arrow in FIG. 4 pointing towards the word “reject”.

The data that pass through the packet filter 15 (in the case of FIG. 4, the data transmitted from the application A 16a as indicated by the solid arrow) are input into the communication interface 11. The communication interface 11 transmits the data to the network using the I/F device 111. When transmitting the data to the network, the communication interface 11 may use cellular communication by the modem 112, wireless LAN communication by the wireless LAN device 113, or another communication method.

[Filtering]

It is determined whether to permit or prohibit data communication for data transmitted from an application based on the UID allocated to the application that is the source of data transmission. Hereinafter, data that are transmitted from an application to which X is allocated as the UID (hereinafter, also referred to as application with a UID of X) are also referred to as data with a UID of X. The filtering condition used to filter data with a UID of X is also referred to as the filtering condition for data with a UID of X.

The packet filter 15 for example has a filtering condition that only allows data communication for data transmitted from an application with a UID of 1. The filtering condition may also be a combination of a plurality of conditions.

The following describes the sequence for data communication when filtering according to this embodiment is performed. The filtering according to this embodiment is assumed to determine whether to permit or prohibit data communication for data transmitted by an application running in the background. The following description of filtering according to this embodiment is based on this assumption.

The filtering according to this embodiment has a set filtering condition such that data communication is prohibited by default (hereinafter, also referred to as default condition to prohibit communication). By the default condition to prohibit communication being set, all data communication is prohibited unless another filtering condition is further set. The default condition to prohibit communication may be set when the communication apparatus 1 is shipped or when the communication apparatus 1 is initialized. In other words, in this embodiment, the “default” refers to the standard operation that is set in advance at a predetermined time (for example, when the communication apparatus 1 is shipped, when the communication apparatus 1 is initialized, or the like).

In the filtering conditions used in this embodiment, in order to perform necessary data communication, a condition to permit data communication (hereinafter, also referred to as condition to permit communication) is set in addition to the default condition to prohibit communication. In this case, the condition to permit communication takes priority over the default condition to prohibit communication.

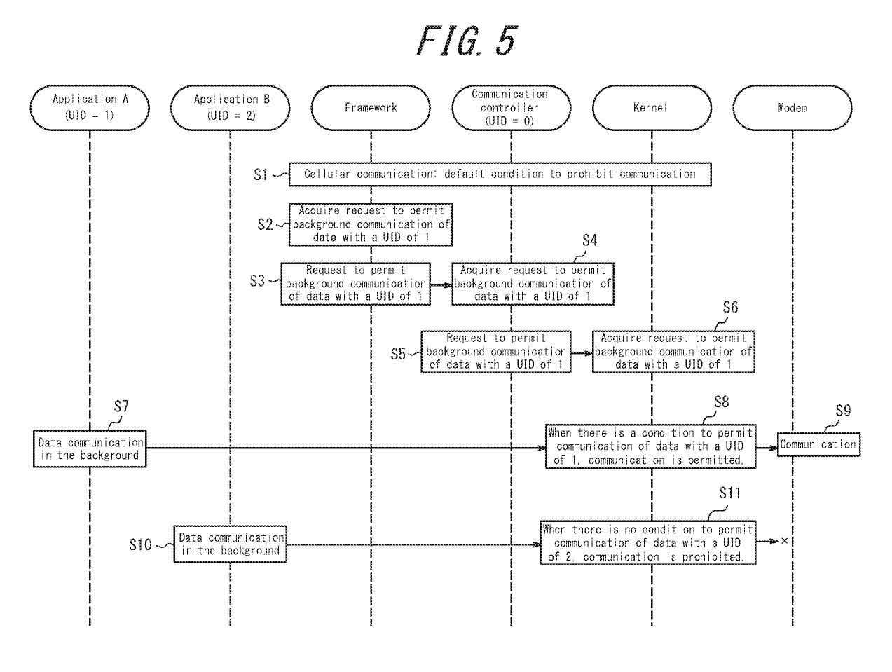

FIG. 5 illustrates the sequence of filtering according to this embodiment. FIG. 5 illustrates the sequence for the application A 16a, application B 16b, framework, communication controller, kernel, and modem 112.

As described above, the modem 112 is hardware that functions as a communication interface to perform cellular communication. In FIG. 4, data communication by cellular communication using the modem 112 is described, but the modem 112 may be replaced by another I/F device 111, such as the wireless LAN device 113, and data communication may be performed by another communication method.

The kernel, communication controller, and framework are software executed by the controller 10. In FIG. 5, the communication controller is allocated 0 as the UID.

The framework is software that includes a functional group for causing applications to operate on the OS. In general, by combining portions of the functional group prepared on the framework, the functions of each application can be implemented.

The kernel is software that forms the nucleus of the OS. Based on processing of the applications and other software, the kernel manages processing on the communication interface 11 and other hardware to allow use of the hardware functions.

The communication controller is a daemon program that executes network related processing and executes processing that connects the framework and the kernel. In particular, the communication controller processes data to allow the kernel to use the functions of the communication interface 11. In this embodiment, the communication controller outputs, to the kernel, conditions for the kernel to determine whether to permit or prohibit data output to the communication interface 11.

In this embodiment, the filtering is described as being performed by the packet filter 15. The packet filter 15 is a virtual processing unit, and the actual filtering is performed by the communication controller and the kernel.

The application A 16a and the application B 16b are processes running on the OS. In FIG. 5, the application A 16a is an application allocated 1 as the UID, and the application B 16b is an application allocated 2 as the UID.

The following describes the sequence illustrated in FIG. 5. In the case of data transmission by an application running in the background, data communication by cellular communication is prohibited by default (step S1). In other words, as a filtering condition, a default condition to prohibit communication is set for data transmitted from an application running in the background. In FIG. 5, the kernel, communication controller, and framework recognize that the default condition to prohibit communication is set. In particular, when the kernel recognizes that the default condition to prohibit communication is set, data are not transmitted to the modem 112.

Next, the framework acquires a request to permit data communication for data with a UID of 1 in the case of an application running in the background (hereinafter, also referred to as request to permit communication of data with a UID of 1) (step S2). The framework then outputs the request to permit communication of data with a UID of 1 to the communication controller (step S3).

The communication controller acquires the request to permit communication of data with a UID of 1 (step S4). Next, the communication controller outputs the request to permit communication of data with a UID of 1 to the kernel (step S5).

The kernel acquires the request to permit communication of data with a UID of 1 (step S6). With the above operations in steps S3 to S6, the request to permit communication of data with a UID of 1 is conveyed to the kernel. In other words, as a filtering condition, a condition to permit communication for data with a UID of 1 is set

Next, when the application A 16a issues a request for data communication while running in the background (step S7), the kernel permits the data communication, since the kernel recognizes that the condition to permit communication for data with a UID of 1 is set (step S8). The modem 112 then performs data communication to transmit the data with a UID of 1 to the network (step S9).

Conversely, when the application B 16b allocated 2 as the UID requests data communication while running in the background (step S10), the kernel recognizes that a condition to permit communication for data with a UID of 2 is not set. Therefore, the kernel prohibits data communication based on the default condition to prohibit communication (step S11).

<Sequence for Data Transmission from an Application>

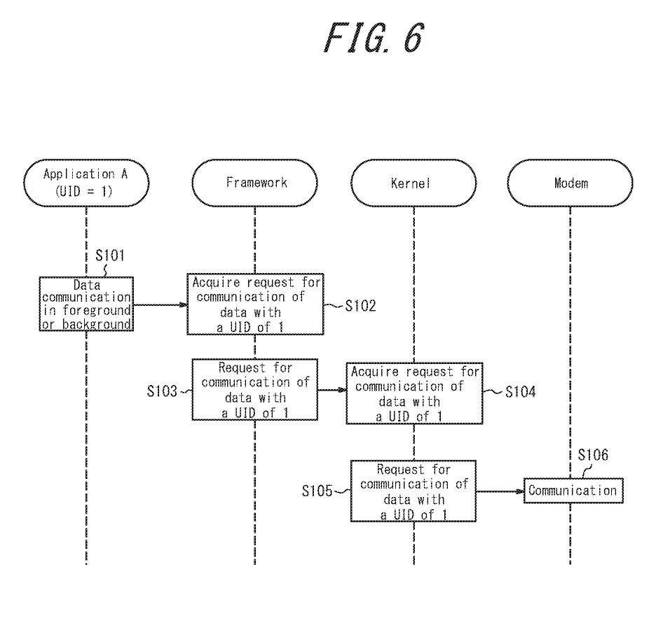

In steps S7 to S9 of FIG. 5, the case of an application requesting data communication and the modem 112 performing data communication has been described. With reference to FIG. 6, the following describes this sequence in greater detail. FIG. 6 illustrates the sequence for the application A 16a, framework, kernel, and modem 112. A description of the application A 16a, framework, kernel, and modem 112 is the same as in FIG. 5 and is therefore omitted.

Whether running in the foreground or the background, the application A 16a outputs a request, to the framework on the OS on which the application A 16a is running, for data communication of data (data with a UID of 1) transmitted from the application A 16a (hereinafter, also referred to as request for communication of data with a UID of 1) (step S101).

The framework acquires the request for communication of data with a UID of 1 (step S102). Next, the framework outputs the request for communication of data with a UID of 1 to the kernel (step S103).

The kernel acquires the request for communication of data with a UID of 1 (step S104). Next, the kernel outputs data based on the request for communication of data with a UID of 1 to the modem 112 (step S105). The modem 112 then performs data communication to transmit the data with a UID of 1 to the network (step S106).

With the operations of the sequence illustrated in FIG. 6 as described above, data transmitted from the application are output to the communication interface 11 and are transmitted to the network.

Filtering to determine whether to permit the data communication based on the UID has been described above. This filtering may prohibit the data communication of the data transmitted from the application B 16b, to which no filtering condition is explicitly set by the user.

### Embodiment 2

The filtering as described above determines whether to permit the data communication of the data based on the UID associated with the data. However, whether to permit the data communication may be determined based on, in addition to the UID, the GID associated with the data.

Here, on some occasions, data having neither UID nor GID associated therewith is transmitted to the kernel. In this case, the kernel cannot determine whether to permit the data communication of the data based on the UID or the GID. A control method of the data communication in this case will be described below as Embodiment 2.

The data having neither UID nor GID associated therewith is, for example, data transmitted from the framework. Such data is generated by an operation that the framework transmits the data on behalf of the application when the application is closed without transmitting data which should be transmitted.

An example occasion where the application is closed without transmitting the data which should be transmitted includes a case where the application, in terminating a connection of a communication using the TCP, transmits the request to terminate connection and is closed before receiving the ACK from the communication device on the network side. In this case, the framework, on behalf of the application, in order to terminate the connection of the communication using the TCP, transmits the data containing the ACK to the communication device on the network side. Since the framework serving as a source of the data containing the ACK is allocated neither the UID nor the GID, the data containing the ACK is associated with nether the UID nor the GID.

The data associated with neither the UID nor the GID always contains, in the header, a protocol number representing the communication protocol. Therefore, the data may be filtered based on the protocol number contained in the data. Hereinafter, data having the header containing a protocol number representing a protocol of X will be referred to as data with the protocol of X.

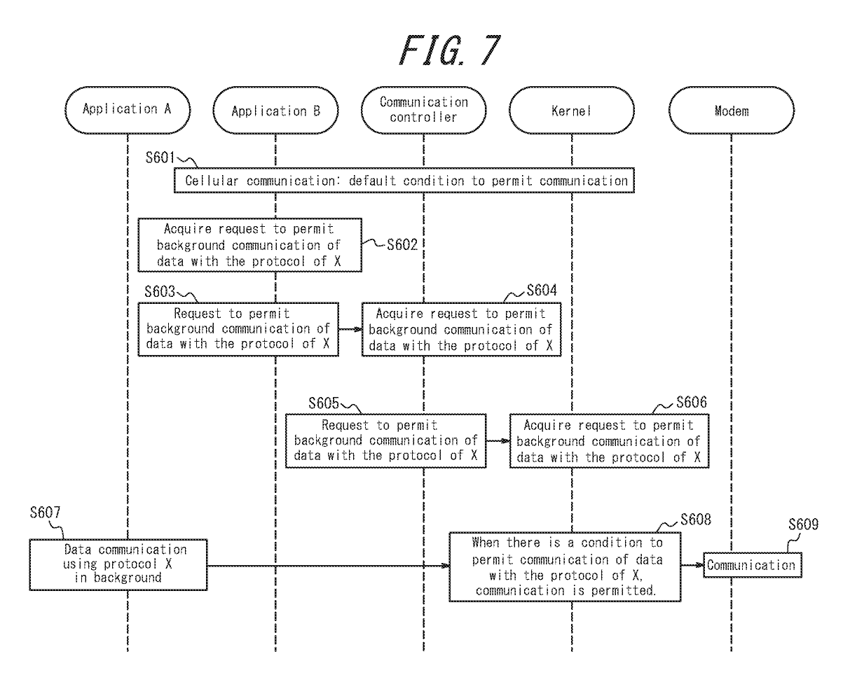

FIG. 7 illustrates the sequence of filtering based on the protocol number. FIG. 7 illustrates a sequence of operations performed by the application A 16a, the framework, the communication controller, the kernel, and the modem 112. Since the application A 16a, the framework, the kernel, and the modem 112 are similar to those in FIG. 5, descriptions thereof will be omitted.

First, when the application running in the background tries to transmit the data, data communication by cellular communication is prohibited by default (step S601).

Subsequently, the framework acquires a request to permit data communication for data with the protocol of X when the application is running in the background. (step S602). Hereinafter, the request to permit data communication for data with the protocol of X is also referred to as a request to permit communication of a protocol of X. Then, the framework outputs, to the communication controller, the request to permit communication of a protocol of X (step S603).

The communication controller acquires the request to permit communication of a protocol of X (step S604). Then, the communication controller outputs, to the kernel, the request to permit communication of a protocol of X (step S605).

The kernel acquires the request to permit communication of a protocol of X (step S606). By following the above steps S602 to 606, the request to permit communication of a protocol of X is transferred to the kernel. That is, as the filtering condition, a condition to permit communication for data of the protocol of X is set.

Next, when the application A 16a running in the background requests the data communication using the protocol of X (step S607), the kernel, recognizing that the condition to permit communication for data with the protocol of X data has been set, permits the data communication (step S608). Then, the modem 112 performs the data communication to transmit data with the protocol of X transmitted from the application A 16a to the network side (step S609).

As described with reference to FIG. 7, whether to permit the data communication may be determined based on the protocol number. Here, for example, when condition to permit communication for data with TCP is set as the filtering condition, every data communication may be substantially permitted.

Therefore, the condition to permit communication set in FIG. 7 may further include a condition associated with the ACK flag contained in the header of the data. That is, the condition to permit communication to authorize a communication of data with the protocol of X and containing 1 as the ACK flag may be set as the filtering condition.

When the condition to permit communication includes containing 1 as the ACK flag, data containing 0 as the ACK flag, that is, the transmission of the initial data is prohibited. When the initial data is not transmitted, the data containing 1 as the ACK flag cannot be transmitted. Therefore, every data communication is substantially prohibited. As described above, however, when the application, after transmitting the request to terminate connection, is closed before acquiring the ACK from the communication device on the network side, the communication of the data containing the ACK transmitted by the framework or a library on behalf of the application is permitted.

As described above, the filtering determines whether to permit the data communication based on the protocol of the data communication. This filtering may determine whether to permit the data communication when the data is associated with neither the UID nor the GID.

Embodiments 1 and 2 mainly describe the methods of prohibiting the data communication by the cellular communication system using the modem 112 as the I/F device 111. However, the I/F device 111 is not limited to the modem 112 but may be the wireless LAN device 113 or the like. That is, the control methods of the data communication of the communication apparatus 1 according to Embodiments 1 and 2 are also applicable to, in addition to the data communication on the cellular communication system, the data communication on another communication system including the wireless LAN communication system.

In Embodiments 1 and 2, data communication may be permitted by default for functions that are necessary to transmit the data for which data communication is permitted. The functions for which data communication is permitted by default may, for example, be a tunneling function of a Virtual Private Network (VPN), a name resolving function of a Domain Name System (DNS), or a tethering function. Permission for data communication related to these functions may be restricted to operations intended by the user. The condition for permitting data communication for these functions may be set as a filtering condition that takes priority over the default condition to prohibit communication.

Further, although the filtering according to Embodiments 1 and 2 are performed on the data communication of the application running in the background, the filtering is not limited to this manner but may be performed on the data communication of the application running in the foreground. That is, the filtering operation may determine whether to permit the data communication of the data transmitted by the application running in the foreground.

(Modification)

As a modification, a filtering operation performed when data is encapsulated for the data communication using the tunneling function of the VPN will be described. In this modification, the communication apparatus 1 further includes a VPN device. The VPN device has a protocol to encapsulate acquired data. The protocol that the VPN device has (hereinafter, also referred to as a VPN protocol) is allocated a unique UID. Hereinafter, the UID allocated to the protocol is also referred to as a UID of the protocol. The VPN device encapsulates data from an application based on this protocol. Then, the VPN device outputs the encapsulated data to the communication interface 11. The encapsulated data lose the association with the UID allocated to the application transmitting the data. The UID of the protocol that encapsulated the data is then newly associated with the encapsulated data.

The VPN device may have a plurality of protocols to encapsulate data. In this case, the UIDs of these protocols differ. The UID of the protocol that encapsulates data is associated with the encapsulated data. When the VPN device has a plurality of protocols to encapsulate data, the UIDs of these protocols belong to a common group. A GID is allocated to this common group. Accordingly, a common GID is associated with the plurality of protocols that the VPN device has. The protocol that the VPN device has may be included in an application.

The VPN protocol, similarly to other communication protocols, is allocated the protocol number. Therefore, the header of the data encapsulated using the VPN protocol contains the protocol number allocated to the protocol used for encapsulation of data.

In case of using the VPN protocol, similarly to a case of using the TCP, acquiring the ACK after the transmission of the data allows confirmation that the data has been transmitted successfully. Here, on some occasions the application transmitting the data by using the VPN, similarly to the case of using the TCP, may be closed after transmitting the request to terminate connection before acquiring the ACK from the communication device on the network side.

In this case, the VPN device, on behalf of the application, transmits the data containing the ACK to the device on the network side in order to terminate the connection to the communication device on the network side. The data containing the ACK is associated with neither the UID nor the GID. However, the header of the data contains the protocol number allocated to the VPN protocol. Therefore, by setting a condition, as the filtering condition, to permit the data communication of the data containing the protocol number allocated to the VPN protocol, the transmission of the ACK from the VPN device is permitted. Accordingly, the connection of the communication performed by the VPN may be terminated successfully.

The modification has been described above. According to this modification, whether to permit the data communication may be determined based on the VPN protocol. Therefore, when the connection of the communication using the VPN is terminated, the transmission of the ACK is prevented from being prohibited.

The communication apparatus, the communication control method, and the program according to one embodiment may control the data communication of data having no identifier associated with a source of the data.

Although exemplary embodiments have been described with reference to the accompanying drawings, it is to be noted that various changes and modifications will be apparent to those skilled in the art based on this disclosure. Therefore, such changes and modifications are to be understood as included within the scope of this disclosure. For example, the functions and the like included in the various components and steps may be reordered in any logically consistent way. Furthermore, components or steps may be combined into one or divided. While this disclosure has been described focusing on apparatuses, this disclosure may also be embodied as a method that includes steps performed by the components of an apparatus. Furthermore, while this disclosure has been described focusing on apparatuses, this disclosure may also be embodied as a method or program executed by a processor provided in an apparatus, or as a non-transitory computer-readable recording medium on which a program is recorded. Such embodiments are also to be understood as included in the scope of this disclosure.

In the above embodiments, wireless LAN has been provided as an example of a data communication method that is not a pay-as-you-go method, but this example is not limiting. Other data communication methods that are not pay-as-you-go methods include Bluetooth® and Ethernet® (Ethernet is a registered trademark in Japan, other countries, or both).

1. A communication apparatus comprising:
a controller configured to
prohibit data communication by default;
receive a request for data communication from an application; and
permit data communication of the application in accordance with a protocol of the data communication requested by the application issuing the request.

2. The communication apparatus according to claim 1, wherein the protocol is used for encapsulating data by a VPN device.

3. The communication apparatus according to claim 1, wherein the data communication of the application is a communication of a particular message contained in the protocol.

4. The communication apparatus according to claim 2, wherein the data communication of the application is a communication of a particular message contained in the protocol.

5. The communication apparatus according to claim 1, wherein the controller prohibits data communication by default when the data communication is cellular communication.

6. The communication apparatus according to claim 2, wherein the controller prohibits data communication by default when the data communication is cellular communication.

7. The communication apparatus according to claim 3, wherein the controller prohibits data communication by default when the data communication is cellular communication.

8. The communication apparatus according to claim 4, wherein the controller prohibits data communication by default when the data communication is cellular communication.

9. The communication apparatus according to claim 1, wherein the controller permits data communication by default when the data communication is wireless LAN communication.

10. The communication apparatus according to claim 2, wherein the controller permits data communication by default when the data communication is wireless LAN communication.

11. The communication apparatus according to claim 3, wherein the controller permits data communication by default when the data communication is wireless LAN communication.

12. The communication apparatus according to claim 4, wherein the controller permits data communication by default when the data communication is wireless LAN communication.

13. The communication apparatus according to claim 5, wherein the controller permits data communication by default when the data communication is wireless LAN communication.

14. The communication apparatus according to claim 6, wherein the controller permits data communication by default when the data communication is wireless LAN communication.

15. The communication apparatus according to claim 7, wherein the controller permits data communication by default when the data communication is wireless LAN communication.

16. The communication apparatus according to claim 8, wherein the controller permits data communication by default when the data communication is wireless LAN communication.

17. A communication control method comprising:
on a communication apparatus,
prohibiting data communication by default;
receiving a request for data communication from an application; and
permitting data communication of the application in accordance with a protocol of the data communication requested by the application issuing the request.

18. A non-transitory computer-readable recording medium including computer program instructions, which when executed by a computer functioning as a communication apparatus, cause the computer to:
prohibit data communication by default;
receive a request for data communication from an application; and
permit data communication of the application in accordance with a protocol of the data communication requested by the application issuing the request.
